(19) United States
(12) Patent Application Publication
(10) Pub. No.: US 2023/0142418 A1
(43) Pub. Date: May 11, 2023

(54) WET NON-WOVEN FABRIC, PREPARATION METHOD THEREFOR AND WATER TREATMENT MEMBRANE CONTAINING WET NON-WOVEN FABRIC

(71) Applicant: SHENZHEN SENIOR TECHNOLOGY MATERIAL CO., LTD., Shenzhen (CN)

(72) Inventors: Li CHEN, Shenzhen (CN); Shuqiu WU, Shenzhen (CN)

(73) Assignee: SHENZHEN SENIOR TECHNOLOGY MATERIAL CO., LTD., Shenzhen (CN)

(21) Appl. No.: 17/757,093

(22) PCT Filed: Dec. 30, 2019
(86) PCT No.: PCT/CN2019/130137

§ 371 Date: Jun. 9, 2022

(51) Int. Cl. B01D 69/10; D04H 1/55; D04H 1/593; D04H 1/44; D04H 1/435; D04H 1/4382; B01D 71/68; C02F 1/44; D21F 5/02; D21F 1/00; D21H 13/24; D21H 19/24; D21H 27/38; D21H 27/08

(52) U.S. Cl. CPC B01D 69/1071; B01D 71/68; C02F 1/44; D04H 1/44; D04H 1/55; D04H 1/435; D04H 1/593; D04H 1/43828; D04H 1/43835; D21F 1/0018; D21F 5/022; D21H 13/24; D21H 19/24; D21H 27/08; D21H 27/38; D10B 2401/10; D10B 2401/063; D10B 2505/04

(57) ABSTRACT

Disclosed are a wet non-woven fabric, the use of the wet non-woven fabric as a supporting layer of a water treatment membrane, a method for preparing the wet non-woven fabric, and a water treatment membrane containing the wet non-woven fabric. The wet non-woven fabric has an average pore size of no greater than 20 µm, a maximum pore size of no greater than 40 µm, and a maximum pore size/average pore size ratio of no less than 1 and no greater than 12.

### TECHNICAL FIELD

The present disclosure belongs to the technical field of non-woven fabric materials, and more particularly, relates to a wet non-woven fabric that can be used as a support layer of a water treatment membrane.

### BACKGROUND ART

Water treatment membrane technology is currently mainly used in the fields of sewage treatment, water supply purification, seawater desalination and pure water preparation, etc. Depending on the different manufacturing materials, the water treatment membranes can be divided into inorganic membranes and organic membranes. The inorganic membranes mainly comprise ceramic membranes, glass membranes and metal membranes, with low filtration accuracy and low selectivity. For the organic membranes, polymer materials, such as cellulose resin, polyvinyl alcohol resin, polysulfone resin, polyamide resin, polyimide resin, etc., are selected as the raw materials, depending on different separation purposes. The organic membranes, due to high filtration accuracy and high selectivity, are widely used in the water resource field and the fields, such as industrial special separation and the like.

However, the polymer functional layer of the organic water treatment membrane (referred to as “water treatment membrane” for short hereinafter) has low mechanical strength and cannot withstand the high hydraulic pressure in the separation process when used alone and therefore, non-woven fabrics are usually used as the supporting layer for it, so as to provide the structural strength.

In order to ensure the high liquid flow and high filtration performance of the water treatment membrane, the requirements on the pore size and its distribution of the functional layer thereof are high. For this reason, the non-woven fabric as the support layer must also be controlled to have the appropriate pore size and uniform pore size distribution.

Polyester non-woven fabrics are usually prepared by a single-layer bonding process. However, compared with the double-layer or multi-layer bonding processes, the single-layer bonding tends to produce large through holes, especially in the parts where the fibers are not uniformly dispersed, and the through holes of the non-woven fabric often lead to that pinholes appear in the coating layer of the water treatment membrane, which is a fatal defect for the water treatment membrane, especially the reverse osmosis membrane, since the high filtration performance of the membrane can no longer be guaranteed.

### SUMMARY

The present disclosure relates to a wet non-woven fabric, wherein the wet non-woven fabric has an average pore size not greater than 20 µm, a maximum pore size not greater than 40 µm, and a maximum pore size/average pore size ratio (i.e. a ratio of the maximum pore size to the average pore size) not less than 1 and not greater than 12.

In one or more embodiments, the maximum pore size/average pore size ratio of the wet non-woven fabric is not less than 1 and not greater than 8, and preferably not less than 1 and not greater than 6.

In one or more embodiments, the average pore size of the wet non-woven fabric is not greater than 15 µm, preferably not greater than 10 µm, and more preferably not greater than 8 µm .

In one or more embodiments, the maximum pore size of the wet non-woven fabric is not greater than 35 µm, and preferably not greater than 30 µm .

In one or more embodiments, the wet non-woven fabric, as a whole, is of a single-layer structure formed of at least two layers combined together.

In one or more embodiments, the at least two layers comprise a first layer and a second layer, and a fibre number of fibers of the first layer and a fibre number of fibers of the second layer are different.

In one or more embodiments, the at least two layers comprise a first layer and a second layer, and the fibers of the first layer comprise two or more kinds of fibers with different fibre numbers; and the second layer comprises two or more kinds of fibers with different fibre numbers.

In one or more embodiments, the first layer is composed of backbone fibers with a fibre number not greater than 9.20 µm and binder fibers with a fibre number not greater than 11.27 µm, and the second layer is composed of backbone fibers with a fibre number not greater than 13.01 µm and binder fibers with a fibre number not greater than 14.55 µm; and

In one or more embodiments, the fibre number of the backbone fibers of the first layer is not greater than that of the backbone fibers of the second layer, and the fibre number of the binder fibers of the first layer is not greater than that of the binder fibers of the second layer.

In one or more embodiments, the fibre number of the backbone fibers of the first layer is not greater than 8.23 µm, e.g., not greater than 7.70 µm, and e.g., between 6.51-7.70 µm .

In one or more embodiments, the fibre number of the backbone fibers of the second layer is not greater than 12.35 µm, e.g., not greater than 12.00 µm, and e.g., between 6.51-12.00 µm.

In one or more embodiments, the fibre number of the binder fibers of the first layer is not greater than 10.89 µm, e.g., not greater than 10.49 µm, and e.g., between 9.65-10.49 µm.

In one or more embodiments, the fibre number of the binder fibers of the second layer is not greater than 10.89 µm, e.g., not greater than 10.49 µm, and e.g., between 9.65-10.49 µm.

In one or more embodiments, a fiber length of the backbone fibers of the first layer is 1-7 mm, e.g., 3-6 mm.

In one or more embodiments, a fiber length of the backbone fibers of the second layer is 1- 7 mm, and preferably 3-6 mm.

In one or more embodiments, a fiber length of the binder fibers of the first layer is 1-7 mm, and preferably 3-6 mm.

In one or more embodiments, a fiber length of the binder fibers of the second layer is 1-7 mm, and preferably 3-6 mm.

In one or more embodiments, a mass fraction of binder fibers of the first layer is 20-40%, and a mass fraction of backbone fibers thereof is 60-80%.

In one or more embodiments, a mass fraction of binder fibers of the second layer is 20-40%, and a mass fraction of backbone fibers thereof is 60-80%.

In one or more embodiments, the wet non-woven fabric has a surface density of 60-100 g/m², a density of 0.70-1.05 g/cm³, and an air permeability of 0.5-4.0 cc/cm²/sec, and a transverse tensile strength thereof is >35 N/15 mm, and/or a longitudinal tensile strength/transverse tensile strength ratio (i.e. a ratio of the longitudinal tensile strength to the transverse tensile strength) thereof is 1.2-4.

In one or more embodiments, the wet non-woven is made of at least one of following: polyester fibers, such as polyethylene terephthalate fibers; polyolefin fibers, such as polyethylene fibers, polypropylene fibers, vinyl chloride fibers or ES fibers; viscose fibers; and acrylic fibers, and preferably is made of polyester fibers.

In one or more embodiments, the backbone fibers are at least one of following: polyester fibers, such as polyethylene terephthalate fibers; polyolefin fibers, such as polyethylene fibers, polypropylene fibers, vinyl chloride fibers or ES fibers; viscose fibers; and acrylic fibers, and preferably are polyester fibers.

In one or more embodiments, the binder fiber of the first layer and the binder fiber of the second layer are each independently at least one selected from the group consisting of undrawn polyester binder fibers, polyolefin fibers, and core-sheath binder fibers.

In one or more embodiments, the undrawn polyester binder fibers are undrawn polyethylene terephthalate fibers.

As used herein, the undrawn polyester binder fibers generally refer to undrawn polyester fibers. Because of being not drawn, they have a relatively low melting point and are suitable for being used as binder fibers. For example, typical undrawn polyester binder fibers are undrawn polyethylene terephthalate fibers.

In one or more embodiments, the core-sheath binder fiber is at least one selected from the group consisting of CoPET/PET sheath-core fibers, PE/PET sheath-core fibers, and ES fibers.

The present disclosure is also related to a use of the wet non-woven fabric herein as a support layer for a water treatment membrane.

In one or more embodiments, the first layer of raw material forms a first surface of the wet non-woven fabric, wherein the first surface is coated with a water treatment membrane material.

The present disclosure is also related to a method of preparing the wet non-woven fabric herein, the method comprising a hot pressing step.

In one or more embodiments, the wet non-woven fabric is a wet non-woven fabric according to one or more embodiments herein, and the method comprises: performing paper-making on the first layer of raw material to obtain a first base paper and performing paper-making on the second layer of raw material to obtain a second base paper, and performing hot pressing compounding on the first base paper and the second base paper.

In one or more embodiments, the hot pressing or the hot pressing compounding is performed using a steel roller/steel roller hot pressing machine; or the hot pressing or the hot pressing compounding is performed using a steel roller/soft roller hot pressing machine.

In one or more embodiments, the method herein further comprises a step of dispersing fibers using a conical fiberizer before the paper-making.

The present disclosure is also related to a water treatment membrane, comprising:
the wet non-woven fabric mentioned herein, and
a water treatment membrane material, coated on the wet non-woven fabric.

In one or more embodiments, the water treatment membrane material is selected from the group consisting of polyvinylidene fluoride, polyacrylonitrile, polyamide, cellulose acetate, polyethylene, polyvinyl chloride, polysulfone and combinations thereof, and preferably is polysulfone, such as polyethersulfone.

In one or more embodiments, the water treatment membrane is one or more of a reverse osmosis membrane, a nanofiltration membrane, an ultrafiltration membrane and a microfiltration membrane.

### BRIEF DESCRIPTION OF DRAWINGS

In order to illustrate the technical solutions of the embodiments of the present disclosure more clearly, the drawings required to be used in the embodiments will be briefly introduced below. It should be understood that the following drawings only show some embodiments of the present disclosure, and therefore should be regarded as a limitation on the scope. For those skilled in the art, other related drawings can also be obtained according to these drawings without any creative efforts.

FIG. 1 is a photograph of the non-woven fabric sample (A4 size) described in Embodiment 1 of the present disclosure;

FIG. 2 is an electron microscope image of the non-woven fabric sample described in Embodiment 1 of the present disclosure;

FIG. 3 is a photograph of the Embodiment Sample 1 described in Embodiment 1 of the present disclosure;

FIG. 4 is an electron microscope image of the surface of the coating layer of the Embodiment Sample 1 described in Embodiment 1 of the present disclosure;

FIG. 5 is an electron microscope image of the cross-section of the Embodiment Sample 1 described in Embodiment 1 of the present disclosure; and

FIG. 6 is an enlarged electron microscope image of the cross-section of the Embodiment Sample 1 in Embodiment 1 of the present disclosure.

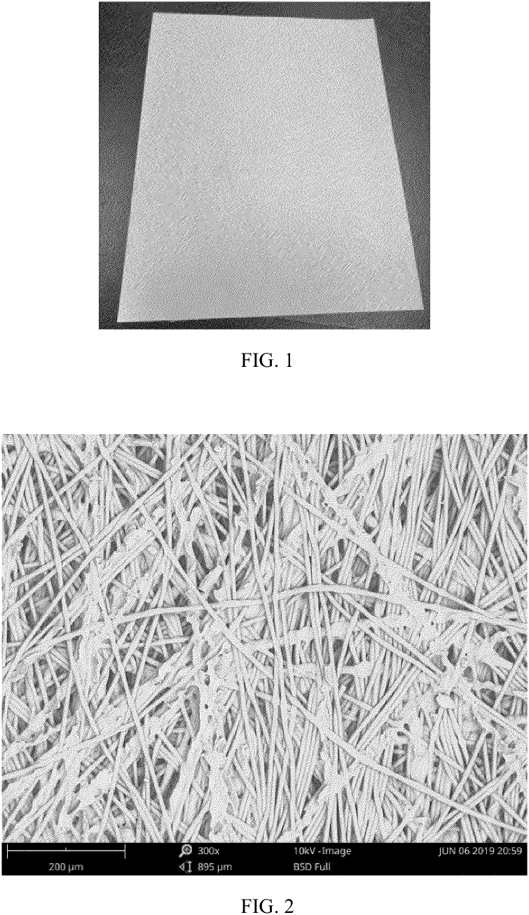

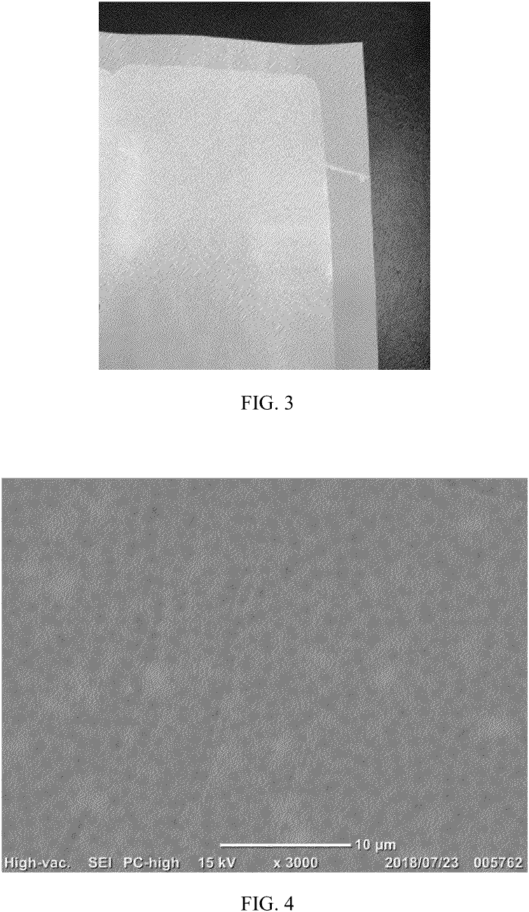

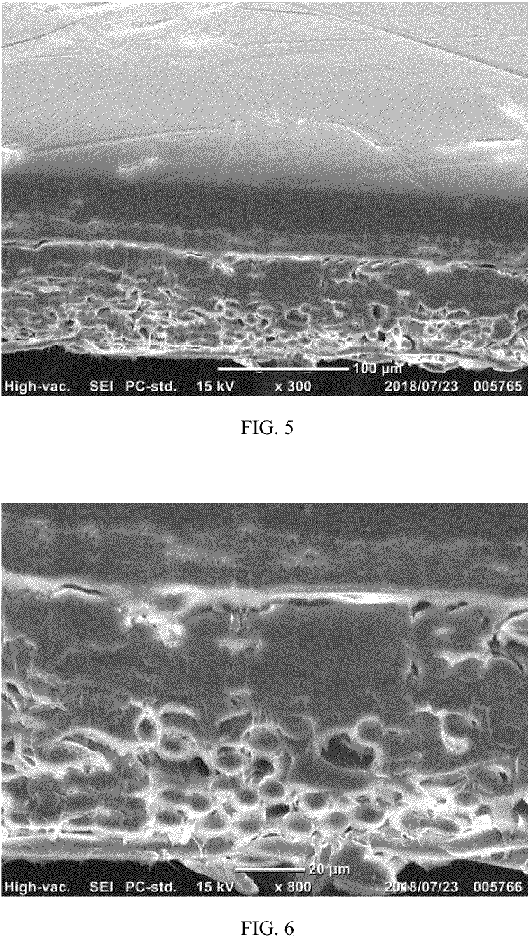

### DETAILED DESCRIPTION OF EMBODIMENTS

In order to make the objectives, technical solutions and advantages of the embodiments of the present disclosure clearer, the technical solutions in the embodiments of the present disclosure will be described clearly and completely below. If the specific conditions are not indicated in the embodiments, the conventional conditions or the conditions suggested by the manufacturer shall be followed. The reagents or instruments used without the manufacturer indicated are conventional products that can be purchased from the market.

Unless otherwise defined herein, scientific and technical terms used in connection with the present disclosure shall have the meanings commonly understood by those of ordinary skill in the art. Exemplary methods and materials are described below, but methods and materials similar or equivalent to those described herein can also be used in the practice or testing of the present disclosure.

The present disclosure provides a wet non-woven fabric, wherein the wet non-woven fabric has an average pore size not greater than 20 µm, a maximum pore size not greater than 40 µm, and a maximum pore size/average pore size ratio not less than 1 and not greater than 12.

In one or more embodiments, the maximum pore size/average pore size ratio of the wet non-woven fabric is not less than 1 and not greater than 8, and preferably not less than 1 and not greater than 6.

In one or more embodiments, the average pore size of the wet non-woven fabric is not greater than 15 µm, preferably not greater than 10 µm, and more preferably not greater than 8 µm .

In one or more embodiments, the maximum pore size of the wet non-woven fabric is not greater than 35 µm, and preferably not greater than 30 µm.

In the process of preparing water treatment membranes, when the average pore size is greater than 20 µm and the maximum pore size is greater than 40 µm, the casting liquid easily penetrates from the upper layer to the lower layer, producing through holes on the coating layer, and finally the casting liquid is adhered to the surface of a guide roller, causing contamination of the foreign body. In contrast, when the pore size is too small, the penetration of the coating liquid on the surface of the non-woven fabric is not deep enough, which easily leads to that the bonding force of the coating layer acting on the support layer is insufficient. In addition, when in the case that the maximum pore size /average pore size ratio is greater than 12, the air entrained in the non-woven fabric is exchanged, at a rate which is not uniform, with water during the phase separation process, at the rate is not uniform, which will affect the uniformity of the membrane formed by curing of the coating layer. Therefore, in one or more embodiments of the present disclosure, the maximum pore size/average pore size ratio is controlled within a range not less than 1 and not greater than 12, for ensuring the uniform distribution of pore size of the non-woven fabric. In order to ensure a lower maximum pore size/average pore size ratio, in one or more embodiments, the dispersion of fibers is performed using a conical fiberizer.

In one or more embodiments, the wet non-woven fabric, as a whole, is of a single-layer structure, which is formed from at least two layers combined together.

As used herein, the expression “as a whole, is of single-layer structure” means that the non-woven fabric is a non-woven fabric as one-piece, instead of plural separate layers, and however the wet non-woven fabric, which as a whole is of a single-layer structure, may be composed of two or more layers combined with each other (e.g., by welding). Therefore, in the present disclosure, the non-woven fabric may comprise two or more layers, which are combined with and cannot be separated with each other.

In one or more embodiments, the at least two layers comprise a first layer and a second layer. The fibre number of fibers of the first layer and the fibre number of fibers of the second layer are different from each other. The first layer and the second layer are combined with or bonded to each other. In one or more embodiments, the first layer and the second layer are welded (butt fused) to each other. In one or more embodiments, the first layer and the second layer are combined or bonded together by thermal bonding.

In one or more embodiments, the at least two layers comprise a first layer and a second layer. The fibers of the first layer comprise two or more kinds of fibers with different fibre numbers; and the second layer comprises two or more kinds of fibers with different fibre numbers.

The non-woven fabric described in the present disclosure is of a single-layer structure which is formed by thermally calendaring and compounding at least two layers of base paper of raw materials with different fiber fiber numbers. The reason for the double-layer composite structure being adopted is that when the through holes appear in only one layer, the other layer can cover them, thereby avoiding the through holes passing through the two layers from being produced in the non-woven fabric. When the two layers of base paper are thermally calendered and compounded, the temperature range used is 220-230° C. The combination of hot pressing rollers can be the metal roller/metal roller combination or the metal roller/soft roller combination. The metal roller/metal roller combination is easy to control the effects and physical properties of the thermal attaching (bonding), and the metal roller/soft roller combination is easy to control the thickness consistency. In addition, the double-layer structure can also be directly prepared by a wet papermaking process, such as, a double-layer inclined wire paper machine or an inclined wire-rotary wire composite paper machine, and then the heat-pressing is performed to fix the wire.

In one or more embodiments, the first layer is composed of backbone fibers with the fibre number not greater than 9.20 µm and binder fibers with the fibre number not greater than 11.27 µm, and the second layer is composed of backbone fibers with the fibre number not greater than 13.01 µm and binder fibers with the fibre number not greater than 14.55 µm.

In one or more embodiments, the first layer is also referred to as the upper layer, with its surface used to be coated with the water treatment membrane material, i.e., the casting liquid.

In one or more embodiments, the second layer is also referred to as the lower layer.

If in the upper layer, the fibre number of the backbone fibers is higher than 9.20 µm and the fibre number of the binder fibers is higher than 11.27 µm, it will increase the possibility of producing large pores and will not help the reductions of the average pore size and the maximum pore size, and the casting liquid will easily penetrate from the upper layer to the lower layer via the through holes, thereby increasing the possibility of defects, such as, pinholes being produced in the coating layer. If in the lower layer, the fibre number of the backbone fibers is higher than 13.01 µm and the fibre number of the binder fibers is higher than 14.55 µm, it will increase the possibility of producing large pores and will not help the reductions of the average pore size and the maximum pore size.

In one or more embodiments, the fibre number of the backbone fibers of the first layer is not greater than the fibre number of the backbone fibers of the second layer, and the fibre number of the binder fibers of the first layer is not greater than the fibre number of the binder fibers of the second layer.

In the present disclosure, by using respectively the fibers with different fibre numbers in the upper layer and the lower layer, with the fibre number of fibers of the upper layer not greater than that of fibers of the lower layer, the air entrained in the lower layer can quickly escape during the phase separation process, thus preventing that the air remains in the lower layer and enters the coating layer to form bubbles, the small bubbles converge into large bubbles, and finally large pinholes are formed in the coating layer.

In one or more embodiments, the fibre number of the backbone fibers of the first layer is not greater than 8.23 µm, or no greater than 7.70 µm, or between 6.51-7.70 µm.

In one or more embodiments, the fibre number of the binder fibers of the first layer is not greater than 10.89 µm, preferably not greater than 10.49 µm, and more preferably between 9.65-10.49 µm.

In one or more embodiments, the fibre number of the backbone fibers of the second layer is not greater than 12.35 µm, preferably not greater than 12.00 µm, and more preferably, between 6.51-12.00 µm.

In one or more embodiments, the fibre number of the binder fibers of the second layer is not greater than 10.89 µm, preferably no greater than 10.49 µm, and more preferably between 9.65-10.49 µm.

If in the lower layer, the fibre number of the backbone fibers is higher than 13.01 µm and the fibre number of the binder fibers is higher than 14.55 µm, it will increase the possibility of producing large pores and will not help to reduce the average pore size and maximum pore size.

In one or more embodiments, the fiber length of the backbone fibers of the first layer is 1-7 mm, and preferably 3-6 mm.

In one or more embodiments, the fiber length of the backbone fibers of the second layer is 1-7 mm, and preferably 3-6 mm.

In one or more embodiments, the fiber length of the binder fibers of the first layer is 1-7 mm, and preferably 3-6 mm.

In one or more embodiments, the fiber length of the binder fibers of the second layer is 1-7 mm, and preferably 3-6 mm.

In one or more embodiments, in the first layer, the mass fraction of binder fibers is 20-40%, and the mass fraction of backbone fibers is 60-80%.

In one or more embodiments, in the second layer, the mass fraction of binder fibers is 20-40%, and the mass fraction of backbone fibers is 60-80%.

In one or more embodiments, the surface density of the wet non-woven fabric is 60-100 g/m².

The non-woven fabric disclosed in the present disclosure has a surface density of 60-100 g/m². When the surface density is less than 60 g/m², it will be difficult for the water treatment membrane to maintain sufficient tensile strength, especially the transverse strength, and the water treatment membrane will not be able to withstand high hydraulic pressure, and will even crack. In addition, when the surface density is too low, the coating liquid may permeate from the upper surface of the non-woven fabric to the lower surface thereof. On the contrary, if the surface density is greater than 100 g/m², under the same density, the thickness will become too large, which will make it impossible to assemble a sufficient filtration area when assembling a filter membrane assembly of a certain specification.

In one or more embodiments, the wet non-woven fabric has a density of 0.70-1.05 g/cm³.

The non-woven fabric described in the present disclosure has a density of 0.70-1.05 g/cm³. When the density is less than 0.70 g/cm³, the penetration of the coating liquid on the surface of the non-woven fabric is too much, and it is easy to penetrate from the upper surface to the lower surface. When the density is greater than 1.05 g/cm³, the penetration of the coating liquid on the surface of the non-woven fabric is not deep enough, which easily leads to insufficient bonding force of the coating layer to the support layer.

In one or more embodiments, the air permeability of the wet non-woven fabric is 0.5-4.0 cc/cm²/sec.

The non-woven fabric described in the present disclosure has an air permeability value of 0.5-4.0 cc/cm²/sec. When the air permeability value is lower than 0.5 cc/cm²/sec, more hydraulic pressure needs to be applied during the filtration process of the water treatment membrane, which makes the filtration efficiency very low. When the air permeability is greater than 4.0 cc/cm²/sec, the pore size of the coating layer is too large, which reduces the filtration efficiency and makes it difficult to obtain good filtration performance.

In one or more embodiments, the transverse tensile strength of the wet non-woven fabric is >35 N/15 mm.

In one or more embodiments, the longitudinal tensile strength/transverse tensile strength ratio of the wet non-woven fabric is 1.2-4.

The non-woven fabric described in the present disclosure has a transverse tensile strength >35 N/15 mm, and a longitudinal tensile strength/transverse tensile strength ratio of 1.2-4. If the tensile strength in the transverse direction is <35 N/15 mm, the strength is too weak, it will be difficult to perform coating on the production line, and even tearing will occur. If the longitudinal tensile strength/transverse tensile strength ratio is greater than 4, longitudinal wrinkles may sometimes occur, which may be related to thermal shrinkage in the transverse direction during thermal calendering. At conditions of low surface density and low density, the tensile strength in the transverse direction will be close to the lower limit specified in this disclosure, which is 35 N/15 mm, and the use of core-sheath bonding fibers in combination with a single binder fiber is an effective improvement method under these conditions, facilitating the increase in the strength.

In conclusion, the present disclosure reduces the probability of defects in the coating layer of the water treatment membrane material, especially pinholes in the coating layer, by controlling the pore size and pore size distribution of the non-woven fabric. By using fibers of different fibre numbers in the upper layer and the lower layer respectively, and making the fibre number of the fibers of the upper layer not greater than that of the lower layer, the rapid exchange of water, air and solvent in the casting liquid during the phase separation of the coating layer is realized, thereby reducing the hole defects of the coating layer.

In one or more embodiments, the wet non-woven fabric is made of at least one of the following: polyester fibers such as polyethylene terephthalate fibers; polyolefin fibers such as polyethylene fibers, polypropylene fibers, vinyl chloride fibers, or ES fibers; viscose fibers; and acrylic fibers.

In one or more embodiments, the wet non-woven fabric is made of polyester fibers.

In one or more embodiments, the backbone fibers are at least one of following: polyester fibers, such as polyethylene terephthalate fibers; polyolefin fibers, such as polyethylene fibers, polypropylene fibers, vinyl chloride fibers or ES fibers; viscose fibers; and acrylic fibers.

In one or more embodiments, the backbone fibers are polyester fibers.

In one or more embodiments, the binder fibers may be any one or combination of undrawn polyester binder fibers, polyolefin fibers and core-sheath binder fibers. The undrawn polyester binder fibers are preferably undrawn polyethylene terephthalate fibers, and the core-sheath binder fibers can be CoPET/PET sheath-core fibers, PE/PET sheath-core fibers, ES fibers, etc.

The present disclosure also provides the use of the wet non-woven fabric described in the present disclosure as a support layer for a water treatment membrane.

In one or more embodiments, the first layer of raw material forms a first surface of the wet non-woven fabric, and the first surface is coated with a water treatment membrane material.

The present disclosure also provides a method for preparing the wet non-woven fabric described in the present disclosure, which comprises a paper-making step and a hot pressing step.

In one or more embodiments, the method comprises performing paper-making on the raw material of the first layer to obtain first base paper, performing paper-making on the raw material of the second layer to obtain second base paper, and performing hot pressing compounding on the first base paper and the second base paper.

In one or more embodiments, the hot pressing or hot pressing compounding is performed using a steel roller/steel roller hot pressing machine; or the hot pressing or hot pressing compounding is carried out using a steel roller/soft roller hot pressing machine.

The present disclosure also provides a water treatment membrane, comprising:
the wet non-woven fabric described in the present disclosure, and
a water treatment membrane material coated on the wet non-woven fabric.

In one or more embodiments, the water treatment membrane material is selected from the group consisting of polyvinylidene fluoride, polyacrylonitrile, polyamide, cellulose acetate, polyethylene, polyvinyl chloride, polysulfone, and combinations thereof, and preferably is polysulfone, such as polyethersulfone.

In one or more embodiments, the water treatment membrane is one or more of a reverse osmosis membrane, a nanofiltration membrane, an ultrafiltration membrane and a microfiltration membrane.

### Embodiment 1

A wet polyester non-woven fabric used as a support layer of a water treatment membrane in this embodiment has specific fiber proportions as shown in Table 1 below.

TABLE 1

| | Upper base paper | | | Lower base paper | | |
|---|---|---|---|---|---|---|
| | Fiber diameter | Fiber length | Mass fraction/% | Fiber diameter | Fiber length | Mass fraction/% |
| Polyethylene terephthalate backbone fiber | 7.13 µm | 3 mm | 60 | 12.00 µm | 3 mm | 70 |
| Undrawn polyethylene terephthalate binder fiber | 10.08 µm | 3 mm | 40 | 10.08 µm | 3 mm | 30 |

A conical fiberizer was used for the dispersion of polyester fibers, and then an inclined wire paper machine was used to prepare upper base paper with a surface density of 37.7 g/m² and lower base paper with a surface density of 37.9 g/m², and then the two layers of base paper were subjected to hot pressing compounding, with the hot pressing machine adopting a steel roller/steel roller combination, to obtain a polyester non-woven fabric with a surface density of 75.6 g/m².

Next, the obtained polyester non-woven fabric was cut to give samples of A4 size, and a polysulfone layer was coated on the outer surface of the upper layer of the sample, wherein the coating liquid composition was 7.5% polysulfone/92.5% N-methylpyrrolidone by weight. After the coating, it was immersed in water for phase separation, taken out after 10 minutes and dried at a room temperature to finally obtain Embodiment Sample 1.

### Embodiment 2

Embodiment Sample 2 was obtained by the same method as in Embodiment 1, except that the hot pressing machine adopts a steel roller/soft roller combination.

### Embodiment 3

A wet polyester non-woven fabric used as a support layer of a water treatment membrane in this embodiment has specific fiber proportions as shown in Table 2 below.

TABLE 2

| | Upper base paper | | | Lower base paper | | |
|---|---|---|---|---|---|---|
| | Fiber diameter | Fiber length | Mass fraction/% | Fiber Specification | Fiber length | Mass fraction/% |
| Polyethylene terephthalate backbone fiber | 7.13 µm | 3 mm | 65 | 7.13 µm | 3 mm | 65 |
| Undrawn polyethylene terephthalate binder fiber | 10.08 µm | 3 mm | 35 | 10.08 µm | 3 mm | 35 |

The preparation process of the non-woven fabric is the same as that of the above-mentioned Embodiment 1, and the hot pressing machine adopts a steel roller/steel roller combination to obtain a polyester non-woven fabric with a surface density of 74.5 g/m².

Next, the obtained polyester non-woven fabric was cut to give samples of A4 size, and a polysulfone layer was coated on the outer surface of the upper layer of the sample, wherein the coating liquid composition was 7.5% polysulfone/92.5% N-methylpyrrolidone by weight. After the coating, it was immersed in water for phase separation, taken out after 10 minutes, and dried at a room temperature to finally obtain Embodiment Sample 3.

### Comparative Embodiment 1

The specific fiber proportions are shown in Table 3 below

TABLE 3

| | Upper base paper | | | Lower base paper | | |
|---|---|---|---|---|---|---|
| | Fiber diameter | Fiber length | Mass fraction/% | Fiber diameter | Fiber length | Mass fraction /% |
| Polyethylene terephthalate backbone fiber | 12.00 µm | 5 mm | 60 | 15.94 µm | 5 mm | 70 |
| Undrawn polyethylene terephthalate binder fiber | 13.01 µm | 5 mm | 40 | 14.55 µm | 5 mm | 30 |

A conical fiberizer was used for the dispersion of polyester fibers, and then an inclined wire paper machine was used to prepare upper base paper with a surface density of 37.5 g/m² and lower base paper with a surface density of 37.9 g/m², and then the two layers of base paper were subjected to hot pressing compounding, with the hot pressing machine adopting a steel roller/steel roller combination, to obtain a polyester non-woven fabric with a surface density of 75.6 g/m². Next, the obtained polyester non-woven fabric was cut to give samples of A4 size, and a polysulfone layer was coated on the outer surface of the upper layer of the sample, wherein the coating liquid composition was 7.5% polysulfone/92.5% N-methylpyrrolidone by weight. After the coating, it was immersed in water for phase separation, taken out after 10 minutes and dried at a room temperature to finally obtain a Comparative Embodiment Sample 1.

### Performance Testing

In the embodiment of this patent, reference standards for the relevant technical indices of the wet polyester non-woven fabric used as the support layer of the water treatment membrane were as follows: the “surface density” of the polyester non-woven fabric was determined according to GB/T 451.2-2002; the “density” of the polyester non-woven fabrics was obtained by dividing the “surface density” of the polyester non-woven fabrics and the “thickness” of the polyester non-woven fabrics; the “thickness” of the polyester non-woven fabrics was determined according to GB/T 451.3-2002 method; the “air permeability” of the polyester non-woven fabrics was determined according to GB/T 24218.15-2018 method; the “pore size” of the polyester non-woven fabrics was determined according to GB/T 32361-2015 method; and the “tensile strength” of the polyester non-woven fabric was determined according to GB/T 12914-2008 method.

The performances of the samples of Embodiments 1 to 3 and the samples of the Comparative Embodiment were tested respectively, and the test results were shown in Table 4 below.

It can be seen from Table 4 that the samples of Embodiments 1-3 of the present disclosure have good performances, especially the two performances, number of pinholes and penetration of the coating liquid to backside, that is, they have no pinholes or the situation that the coating liquid penetrates to the backside. However, the Comparative Embodiment Sample has the average pore size of 16.1 µm, the maximum pore size of 134 µm, and the maximum pore size/average pore size ratio of 8.3, the coating layer of the water treatment membrane prepared therefrom has more than 100 pinholes, and the amount of the coating liquid penetrating to the backside is greater than 0.2 m²/m². Therefore, the performances of the water treatment membranes prepared in the Embodiments of the present disclosure are significantly better than those of the water treatment membranes obtained in the Comparative Embodiment.

TABLE 4

| | Polyester non-woven fabric | | | | | | | | Coating layer | |
|---|---|---|---|---|---|---|---|---|---|---|
| | Sur fac e den sity | De nsit y | Air perme ability | Ave rage por e size | Maxi mum pore size | Maxi mum pore size/a verag e pore size | Trans verse tensil e stren gth | Longit udinal tensile streng th /trans verse tensile streng th ratio | Num ber of pinh oles | Coati ng liquid penet rating to backs ide |
| | g/m ² | g/c m³ | cc/cm ²/s | µm | µm | | N/15 mm | | pinh ole/ m² | m²/m ² |
| Embodiment 1 sample | 75.6 | 0.76 | 2.2 | 7.7 | 30 | 3.9 | 42 | 1.8 | 0 | 0 |
| Embodiment 2 sample | 76.1 | 0.82 | 1.7 | 6.1 | 25 | 4.1 | 51 | 2.0 | 0 | 0 |
| Embodiment 3 sample | 74.5 | 0.80 | 1.9 | 4.9 | 19 | 3.9 | 67 | 2.1 | 0 | 0 |
| Comparative embodiment sample | 75.4 | 0.71 | 2.7 | 16.1 | 134 | 8.3 | 37 | 2.5 | >100 | >0.2 |

The above are only preferred embodiments of the present disclosure, and are not intended to limit the present disclosure. For those skilled in the art, the present disclosure may have various modifications and variations. Any modifications, equivalent replacements, improvements, etc., made within the spirit and principle of the present disclosure, shall fall within the protection scope of the present disclosure.

### Industrial Applicability

The present disclosure reduces the probability of occurrence of defects in the coating layer of the water treatment membrane material, especially pinholes in the coating layer, by controlling the pore size and pore size distribution of the polyester non-woven fabric. By using fibers of different fibre number in the upper layer and the lower layer respectively, and making the fibre number of the fibers of the upper layer not greater than that of the lower layer, the rapid exchange of water, air and solvent in the casting liquid during the phase separation of the coating layer is realized, thereby reducing generation of hole defects of the coating layer.

1-20. (canceled)

21. A wet non-woven fabric, wherein the wet non-woven fabric has an average pore size not greater than 10 µm, a maximum pore size not greater than 40 µm, and a maximum pore size/average pore size ratio not less than 1 and no greater than 12;
the wet non-woven fabric, as a whole, is of a single-layer structure formed of at least two layers combined together, wherein the at least two layers comprise a first layer and a second layer;
the first layer is composed of backbone fibers with a fibre number not greater than 9.20 µm and binder fibers with a fibre number not greater than 11.27 µm, and the second layer is composed of backbone fibers with a fibre number not greater than 13.01 µm and binder fibers with a fibre number not greater than 14.55 µm; and
the fibre number of the backbone fibers of the first layer is not greater than that of the backbone fibers of the second layer, and the fibre number of the binder fibers of the first layer is not greater than that of the binder fibers of the second layer.

22. The wet non-woven fabric according to claim 21, wherein a fibre number of fibers of the first layer and a fibre number of fibers of the second layer are different.

23. The wet non-woven fabric according to claim 21, wherein fibers of the first layer comprise two or more kinds of fibers with different fibre numbers; and
the second layer comprises two or more kinds of fibers with different fibre numbers.

24. The wet non-woven fabric according to claim 21, wherein the maximum pore size/average pore size ratio of the wet non-woven fabric is not less than 1 and not greater than 6.

25. The wet non-woven fabric according to claim 24, wherein the fibre number of the backbone fibers of the first layer is not greater than 8.23 µm;
the fibre number of the backbone fibers of the second layer is not greater than 12.35 µm;
the fibre number of the binder fibers of the first layer is not greater than 10.89 µm; and/or,
the fibre number of the binder fibers of the second layer is not greater than 10.89 µm.

26. The wet non-woven fabric according to claim 24, wherein the fibre number of the backbone fibers of the first layer is not greater than 7.70 µm;
the fibre number of the backbone fibers of the second layer is not greater than 12.00 µm;
the fibre number of the binder fibers of the first layer is not greater than 10.49 µm; and/or,
the fibre number of the binder fibers of the second layer is not greater than 10.49 µm.

27. The wet non-woven fabric according to claim 24, wherein a fiber length of the backbone fibers of the first layer is 1-7 mm;
a fiber length of the backbone fibers of the second layer is 1-7 mm;
a fiber length of the binder fibers of the first layer is 1-7 mm; and/or
a fiber length of the binder fibers of the second layer is 1-7 mm.

28. The wet non-woven fabric according to claim 24, wherein in the first layer, a mass fraction of the binder fibers is 20-40%, and a mass fraction of the backbone fibers is 60-80%; and/or
in the second layer, a mass fraction of the binder fibers is 20-40%, and a mass fraction of the backbone fibers is 60-80%.

29. The wet non-woven fabric according to claim 21, wherein the wet non-woven fabric has a surface density of 60-100 g/m², a density of 0.70-1.05 g/cm³, an air permeability of 0.5-4.0 cc/cm²/sec, a transverse tensile strength of >35 N/15 mm, and/or a longitudinal tensile strength/transverse tensile strength ratio of 1.2-4.

30. The wet non-woven fabric according to claim 21, wherein the wet non-woven fabric is made of at least one selected from the group consisting of: polyester fibers; polyolefin fibers; viscose fibers; and acrylic fibers.

31. The wet non-woven fabric according to claim 24, wherein the backbone fibers are at least one selected from the group consisting of: polyester fibers; polyolefin fibers; viscose fibers; and acrylic fibers; and/or
the binder fibers of the first layer and the binder fibers of the second layer are each independently at least one selected from the group consisting of undrawn polyester binder fibers, polyolefin fibers, and core-sheath binder fibers.

32. The wet non-woven fabric according to claim 31, wherein the polyester fibers are polyethylene terephthalate fibers.

33. The wet non-woven fabric according to claim 31, wherein the polyolefin fibers are polyethylene fibers, polypropylene fibers, vinyl chloride fibers or ES fibers.

34. The wet non-woven fabric according to claim 31, wherein the undrawn polyester binder fibers are undrawn polyethylene terephthalate fibers.

35. The wet non-woven fabric according to claim 31, wherein the core-sheath binder fibers are at least one selected from the group consisting of CoPET/PET sheath-core fibers, PE/PET sheath-core fibers, and ES fibers.

36. A method of preparing the wet non-woven fabric according to claim 34, comprising a paper-making step and a hot pressing step.

37. The method according to claim 36, wherein in the wet non-woven fabric, a fibre number of fibers of the first layer and a fibre number of fibers of the second layer are different, and
the method comprises: performing paper-making on a first layer of raw material to obtain first base paper, performing paper-making on a second layer of raw material to obtain second base paper, and performing hot pressing compounding on the first base paper and the second base paper.

38. The method according to claim 36, wherein the method further comprises a step of dispersing fibers using a conical fiberizer, before the paper-making.

39. A water treatment membrane, comprising:
the wet non-woven fabric according to claim 21, and
a water treatment membrane material, coated on the wet non-woven fabric.

40. The water treatment membrane according to claim 39, wherein the water treatment membrane material is selected from the group consisting of polyvinylidene fluoride, polyacrylonitrile, polyamide, cellulose acetate, polyethylene, polyvinyl chloride, polysulfone and combinations thereof.
